(19) United States
(12) Patent Application Publication
(10) Pub. No.: US 2018/0007001 A1
(43) Pub. Date: Jan. 4, 2018

(54) PROVIDING SECURITY SERVICE

(71) Applicant: HANGZHOU H3C TECHNOLOGIES CO., LTD., Zhejiang (CN)

(72) Inventor: Songer Sun, Beijing (CN)

(21) Appl. No.: 15/543,724

(22) PCT Filed: Apr. 20, 2016
(86) PCT No.: PCT/CN2016/079702

§ 371 Date: Jul. 14, 2017

(30) Foreign Application Priority Data
Apr. 21, 2015 (CN) 201510191310.0

(51) Int. Cl. H04L 29/06

(52) U.S. Cl. CPC H04L 63/0218; H04L 63/205; H04L 63/0464

(57) ABSTRACT

In an example, a security service providing system receives a service request for requesting security service for a target flow, determine a security device for providing security service for the target flow and first service configuration information and next-hop information of the security device according to security service information carried in the service request, and configure the first service configuration information and the next-hop information of the security device onto the security device, so that the security device provides security service to the target flow according to the first service configuration information and forwards the target flow according to the next-hop information

### BACKGROUND

Different users on the Internet may share software or hardware resource by the cloud computing technology. In the cloud computing technology, a concept “tenant” is introduced, and different tenants in a “cloud” environment may share infrastructures such as a server and a gateway in the cloud. Different tenants may have different demands for security protection, and may select a cloud security service according to their own needs. For example, some tenants may select a security service using Fire Wall technology, and other tenants may select a security service using Load Balancing technology.

### BRIEF DESCRIPTION OF THE DRAWINGS

FIG. 1 schematically illustrates an architecture of a security service providing system according to an example of the disclosure;

FIG. 2 schematically illustrates a display interface of a security cloud service module according to an example of the disclosure;

FIG. 3 schematically illustrates an architecture of a security service providing system according to an example of the disclosure;

FIG. 4 schematically illustrates a flowchart for a method for security service providing according to an example of the disclosure; and

FIG. 5 schematically illustrates a security service providing device according to an example of the disclosure.

### DETAILED DESCRIPTION OF THE EMBODIMENTS

According to an example of the disclosure, a security service providing system is provided. The system is a security-as-a-service (SaaS) system and provides “security” as a service to a user. A user may customize a security service by the system according to an actual service application without paying attention to the device deployment for providing the security service. The customization may include defining security service information such as a service type, a bandwidth resource and a security service policy of the security service.

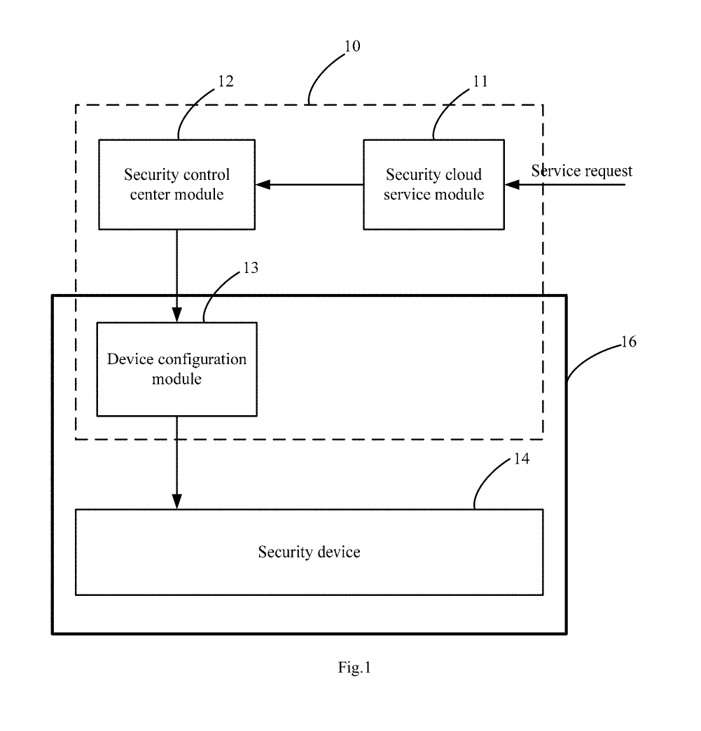

FIG. 1 schematically illustrates an architecture of a security service providing system. As illustrated in FIG. 1, a security service providing system 10 may include a security cloud service module 11, a security control center module 12 and a device configuration module 13. In the example, a security device 14 may provide underlying physical support for the security service providing system. The security device 14 may be one or more devices for providing a security function, such as a gateway, a forwarder or a smart terminal. For example, security configuration may be performed on a gateway so as to enable a security function of the gateway. The security device 14 may be a physical device, or a virtual device such as virtual machine. The one or more security devices 14 may be distributed into different locations. As shown in FIG. 1, security configurations on the security device 14 may be managed by the device configuration module 13 in a centralized way, and the detailed process for the configurations will be described hereinafter. The device configuration module 13 and the security device 14 may be collectively termed as a “security resource pool 16”. The above-mentioned modules will be described below.

The security cloud service module 11 may receive a service request for requesting security service with respect to a target flow, wherein security service information is carried in the service request. The security cloud service module 11 may transmit the security service information to the security control center module 12.

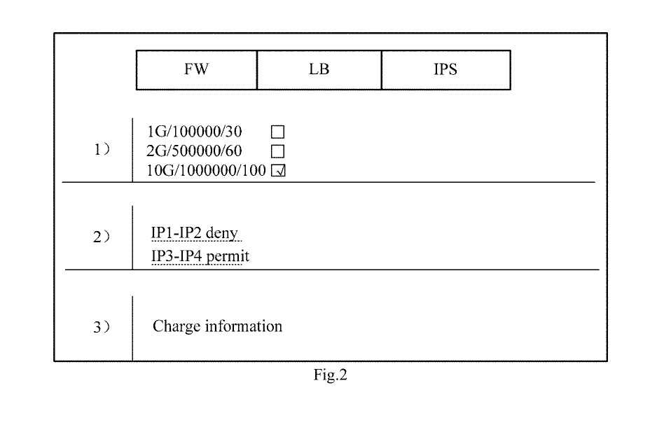

The security cloud service module 11 may be viewed as a portal of the security service providing system. A user may customize, through the portal, information of a desired security service such as service type, bandwidth resource and security service policy. For example, a user may input a pre-determined website www.cloudsecurity.com on a terminal device (e.g., personal computer) to access the security cloud service module 11. FIG. 2 illustrates an example of the display interface of the security cloud service module. However, only part of the content which can be displayed is shown on the display interface. The content to be displayed and the display manner may vary according to actual demands. For example, some security services may be displayed on the display interface to be selected by the user, such as a Firewall (FW) module, Load Balancing (LB) module and Intrusion Prevention System (IPS) module. In case that a tenant requests for public cloud service, when a security service is to be added for a target flow, security service information of the security service may be customized by the security cloud service module 11.

In an example, a security service may be applied to a target flow as a value-added service, and the application scope may be flexibly defined. For example, the security service may be applied to all service flows, or to part of the service flows.

In another example, security service information of a security service may include a service type of the security service. A user may select the service type according to actual demands, and may select one or more service types. For example, the user may select one of the “FW” service, “LB” service or “IPS” service, or select both the “FW” service and “LB” service and such like on the display interface in FIG. 2. For a certain type of security service, the user may further customize service policy of the security service. For example, when an icon representing a FW service module is clicked on the display interface, its corresponding content may be displayed. Referring to part 1) in FIG. 2, the security service providing system may provide to the user FW services of different levels including, for example, 1G/100000/30 (which means throughput/concurrency value/number of policies), 2G/500000/60, and 10G/1000000/100. When selecting a FW service of 10G/1000000/100, the user may make further definitions on the FW service in part 2). For example, the user may set that the Fire Wall allows the packets in the address field IP3-IP4 to pass through and denies the packets in the address field IP1-IP2. Further, charge information for a security service may be displayed in part 3), wherein the charge information indicates how to charge for a security service.

In another example, security service information of a security service customized by a user may further include a service order associated with its service type. If a user customizes two or more types of security services, for example, the user selects three types of security services including “FW”, “LB” and “IPS” on the display interface illustrated in FIG. 2, then the user may designate a service order for executing each of the security services for a target flow, in addition to the above-described content of the security services. For example, for a target flow, the FW security service may be firstly executed, then the LB service, and lastly the IPS service; or the LB service may be firstly executed, then the FW service, and lastly the IPS service.

Further, security service information of a security service may not be limited to the above described, and may be flexibly set according to the service type of the security service.

When receiving a service request for a target flow, the security cloud service module 11 may transmit security service information carried in the service request to the security control center module 12. For example, the security service information may be transmitted in a Restful message.

The security control center module 12 may determine, according to the security service information, a security device 14 to provide a security service for the target flow, and further determine first service configuration information and next-hop information of the security device 14. The security control center module 12 may further transmit the determined first service configuration information and next-hop information to the device configuration module 13.

In the example, the security control center module 12 functions as a core management module in the security service providing system, which may assign a security device 14 for the security service customized by the security cloud service module 11, determine the first service configuration information for the assigned security device 14 and design a corresponding flow forward path.

Since a service flow usually goes through a convergence device or core device in the network, thus a target flow arriving at the convergence device or core device may be guided to a security device. Accordingly, the security control center module 12 may also determine the next-hop information of the convergence device or core device, wherein the next-hop information indicates a next-hop security device for the target flow. When arriving at the last security device indicated by the security service information, the target flow may return to the convergence device or core device, or go to a next-hop device on the flow forward path. Thus the security control center module 12 may determine the next-hop information of the last security device where the target flow arrives, so as to indicate whether the next hop of the target flow arrives at a convergence device or core device, or a next-hop device on the flow forward path.

For example, suppose that the user demands a FW service of 10G/1000000/100 (which means throughput/concurrency value/number of policies), an IPS service of 100M/100000 (which means throughput/concurrency value) and a LB service of 1G/50 (which means throughput/number of VIP virtual services) without designating a service order. Then the security control center module 12 may determine which security devices are capable of providing the demanded services when receiving security service information corresponding to the above demand.

Suppose that the security control center module 12 determines that a device A may provide a IPS service of 100M/100000, a device B may provide a FW service of 10G/1000000/100, and a device C may provide a LB service of 1G/50. Then it can be determined that the security devices through which the target flow is to go may include the device A, the device B and the device C. Since the service order is not designated, the security control center module 12 may determine the service order freely or according to a preset rule. Usually, the security devices may be merely part of devices on the flow forward path for the target flow. For example, suppose that a complete flow forward path for a target flow is “device F→device D→device C→device A→device B→device G→device W”, wherein the device A, the device B and the device C are security devices in the security resource pool and other devices are non-security devices, for example, the device D may be a convergence device or core device. In order to guide the target flow to the device C as a security device, the security control center module 12 may configure the next-hop information of a device (such as the device D) before the device C on the flow forward path, to indicate the device C as the next-hop device for the target flow. Further, the security control center module 12 may configure the next-hop information of the device C to indicate the device A as the next-hop device for the target flow, and may further configure the first service configuration information of the device C to include LB-related configuration information. Further, the next-hop information of the device A may be configured to indicate the device B as the next-hop device for the target flow; and the first service configuration information of the device A may include IPS-related configuration information. The next-hop information of the device B may be configured to indicate the device G or the device D as the next-hop device for the target flow, and the first service configuration information of the device B may include FW-related configuration information. When the next-hop information and the first service configuration information are configured on respective security devices in the security resource pool, the target flow may be guided to sequentially go through the respective security devices to enjoy the security services provided by the security devices. The security device may transmit the target flow to the next-hop device through, for example, tunneling technology.

In another example, the service order for the security service may be pre-defined. The security control center module 12 may determine a flow forward path for the target flow according to the pre-defined service order. For example, if the security service information received by the security cloud service module 11 includes at least two service types respectively associated with a service policy and a service order, the security control center module 12 may firstly determine security devices to provide security services for the target flow and the first service configuration information of each security device according to the at least two service types and the service policies respectively associated with each service type. For example, it may be determined that a device A provides the IPS service, a device B provides the FW service and a device C provides the LB service. Then, the next-hop information of each security device may be determined according to the pre-defined service order and the above determined first service configuration information of each security device. Suppose that the pre-defined service order is “FW→IPS→LB”, the flow forward path may be determined as “device B→device A→device C”. That is, the next-hop information of the device B indicates the device A as the next-hop device for the target flow, and the next-hop information of the device A indicates the device C as the next-hop device for the target flow. Additionally, the next-hop information of a convergence device or a core device for guiding the target flow to the first security device (i.e., device B) on the flow forward path, or the next-hop information of the last security device (i.e., device C) on the flow forward path may be determined referring to the previously-described example.

Further, the security service information received by the security cloud service module 11 may be a text string or information in a XML format (as illustrated in FIG. 2). Such security service information may fail to be directly configured on the security devices because the security devices usually have their own service configuration standard interfaces. Thus, the security control center module 12 may perform format conversion on the security service information, and convert the security service information into the first service configuration information for configuring the security device to provide security service. For example, suppose that the security service information received by the security control center module 12 includes a policy to be configured for the FW service, such as denying the packets in the address field IP1-IP2. The security service information may be further converted into a standard configuration format applicable for the security device, such as Set Rule=f (IP1, IP2, deny). This example is illustrative and the specific format conversion may be executed according to the specifications of different devices.

The security control center module 12 may transmit the determined first service configuration information and next-hop information of each security device, to the device configuration module 13 in a Netconf message. The security control center module 12 may transmit the determined next-hop information of the convergence device or the core device, to the device configuration module 13 in a Netconf message.

The device configuration module 13 may configure the first service configuration information and the next-hop information of each security device into the security device, so that the security device may provide security service for the target flow according to the first service configuration information and guide the target flow according to the next-hop information. For example, the device configuration module 13 may distribute the first service configuration information and the next-hop information corresponding to each security device, to the security device in a XML message.

The device configuration module 13 may further configure the next-hop information of the core device onto the core device so as to enable the core device to transmit the target flow to the security device determined by the next-hop information of the core device, or configure the next-hop information of the convergence device onto the convergence device so as to enable the convergence device to transmit the target flow to the security device determined by the next-hop information of the convergence device.

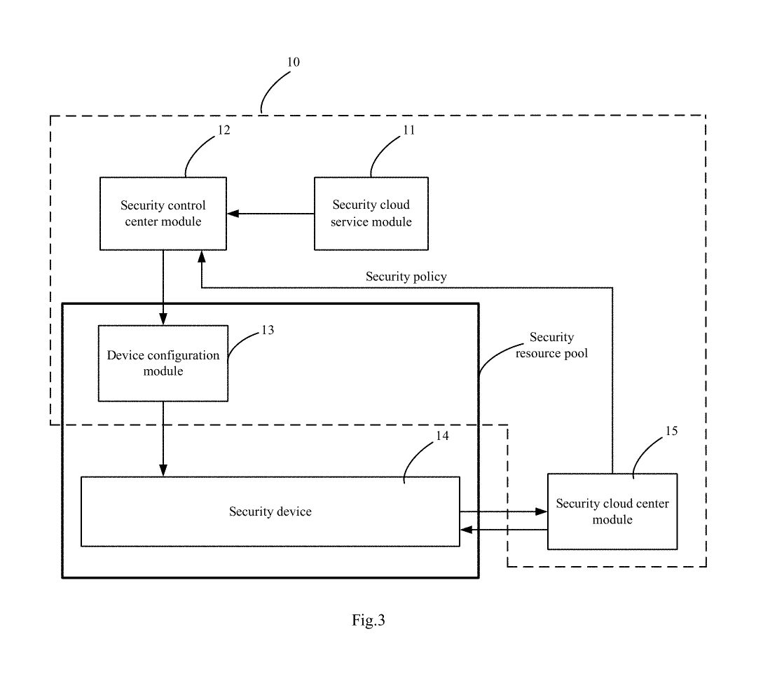

In an example, the security service providing system may further include a security cloud center module. Referring to FIG. 3, the system may further include a security cloud center module 15. When providing a security service for the target flow, the security device 14 may receive some unknown flow. For example, the security device 14 may usually process a packet according to a preset rule, such as allowing a packet matching the preset rule to pass through. The preset rule may be distributed onto the security device 14 in first service configuration information. When the security device 14 finds no rule to match a packet, the packet belongs to an unknown flow, and the security device 14 may transmit the unknown flow onto the security cloud center module 15 for security analysis.

The security cloud center module 15 may perform security analysis on an unknown flow. For example, the security cloud center module 15 may analyze the flow to determine whether the flow is safe, according to data acquired from respective devices in the cloud. If the analysis result indicates that the flow has an exploit risk, the security cloud center module 15 may update a feature library according to the analysis result. The feature library may include features on which the IPS service depends, so that the security device for providing the IPS service may provide security service for the target flow according to the updated feature library, such as performing a corresponding processing on a packet matching a specific feature. For example, the security cloud center module 15 may distribute a feature in the updated feature library to the security device, or the security device may also actively acquire the feature from the security cloud center module 15.

In another example, the security cloud center module 15 may, from analysis on an unknown flow transmitted from the security device, determine that the unknown flow has a high security risk which may cause security problems. In such circumstance, the security cloud center module 15 may extract key information (such as source IP address) from the unknown flow of a high risk, so as to generate a corresponding security policy (e.g., a packet in the source IP address field of the flow of a high risk is not permitted to pass through), and transmit the security policy to the security control center module 12 to be distributed to the security device by the security control center module 12. However, a security device may also choose whether to accept the generated security policy, and if the security device chooses not to accept, the security control center module 12 may not distribute the security policy to the security device.

The security policy generated by the security cloud center module 15 is direct to the security risk discovered in data analysis, and the generated security policy may be used to protect the target flow together with service policy in the security service information received by the security cloud service module 11. Besides, since the generated security policy is a policy to cope with a global risk, it can be configured onto all security devices in the similar way as for the first service configuration information. For example, the security policy may be converted into second service configuration information by the security control center module 12, and then distributed by the device configuration module 13 to the security device. A user may also choose whether to accept the above-mentioned security policy generated by the security cloud center module 15. For example, if the user instructs not to accept the security policy generated by the security cloud center module 15 through the security cloud service module 11, the security control center module 12 may not convert the security policy generated by the security cloud center module 15 into second service configuration information to transmit it to the device configuration module 13.

In this example, the security service providing system may enable an automatic process from request to configuration for security service. As long as a user customizes a desired security service on the security cloud service module as a portal, the security service providing system may automatically configure a security device in the security resource pool according to security service information, so as to guide a target flow to the security device and provide security service according to the user demand. In this way, the efficiency for providing security service may be improved, and further, in contrast to a method in which a security device is manually configured according to security service information, the work for manual operation or maintenance may be greatly reduced.

Further, the architecture of the security service providing system in this example has good openness. For example, any security device from different manufactures can be added into the security resource pool, as long as it satisfies a standard protocol. Thus, various types of security services may be added flexibly and be presented to the user for selection.

FIG. 4 illustrates an example of a method for security service providing according to the disclosure. As illustrated in FIG. 4, the method may include blocks 401, 402 and 403.

At block 401, the security control center module of the security service providing system may receive security service information.

For example, the security service information may be received by the security control center module 12 from the security cloud service module 11. The security service information is carried in a service request for requesting security service for the target flow, received by the security cloud service module 11. The security service information may include one or more service types respectively associated with a service policy and a service order.

At block 402, the security control center module may determine a security device to provide security service for the target flow and determine the first service configuration information and the next-hop information of the security device according to the security service information.

For example, the security control center module 12 may determine a security device to provide security service for the target flow according to the service type of security service and the service policy associated with the service type, which are included in the security service information, and further determine the first service configuration information and the next-hop information of the security device.

At block 403, the security control center module may distribute the first service configuration information and the next-hop information of the security device onto the security device, so as to enable the security device to provide security service for the target flow according to the first service configuration information and forward the target flow according to the next-hop information.

For example, the security control center module 12 may transmit the first service configuration information and the next-hop information determined in block 402 to the device configuration module 13. The device configuration module 13 may distribute the first service configuration information and the next-hop information to the corresponding security device in such as an XML message.

The details of this method may refer to the above-described example, and this method may realize automatic delivery of security service.

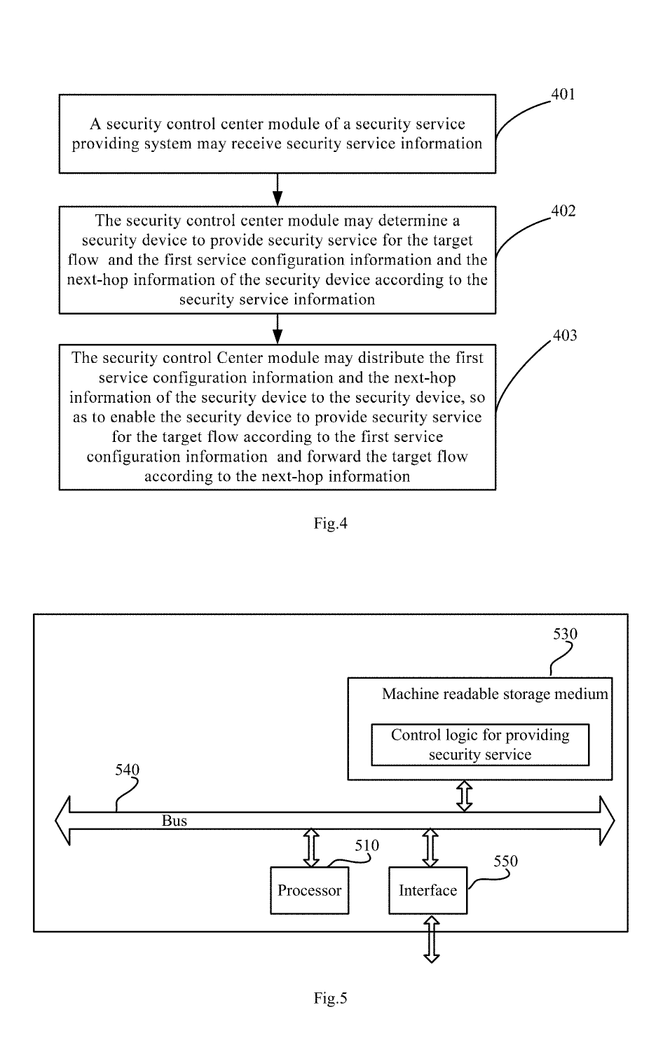

FIG. 5 illustrates an example of a security service providing device in this disclosure. As illustrated in FIG. 5, the device may include a processor 510, machine readable storage medium 530 and an internal bus 540. The processor 510 may be a central processing unit (CPU). The machine readable storage medium 530 may be a non-volatile storage medium and store machine readable instructions corresponding to control logic for providing security service. The processor 510 may communicate with the machine readable storage medium 530 via the internal bus 540. In other possible manners, the device may also include an interface 550 to communicate with other devices or components.

The processor 510 may perform the function of providing security service by executing the machine readable instructions in the machine readable storage medium 530.

In different examples, the machine readable storage medium 530 may be a Random Access Memory (RAM), a volatile storage medium, a non-volatile storage medium, a flash memory, a storage drive (such as hard disk drive), a solid state drive, other types of storage disk (such as optic disc and DVD) or similar types of storage medium, or combinations thereof

The foregoing examples are merely illustrative but not intended to limit the disclosure, and any modifications, equivalent substitutions, adaptations, thereof made without departing from the spirit and scope of the disclosure shall be encompassed in the claimed scope of the appended claims.

1. A security service providing system, comprising:
a security cloud service module to receive a service request for requesting security service with respect to a target flow, wherein security service information is carried in the service request;
a security control center module to determine a security device for providing the security service to the target flow and first service configuration information and next-hop information of the security device according to the security service information; and
a device configuration module to configure the first service configuration information and the next-hop information onto the security device, so that the security device provides the security service to the target flow according to the first service configuration information and forwards the target flow according to the next-hop information.

2. The system according to claim 1, wherein:
the security service information includes one or more service types respectively associated with a service policy and a service order;
the security control center module determines the security device and the first service configuration information of the security device according to the service type and the service policy associated with the service type; and
the security control center module determines the next-hop information of the security device according to the service order and the first service configuration information.

3. The system according to claim 1, wherein,
the security control center module further determines the next-hop information of a non-security device immediately before a security device, wherein the non-security device is to forward the target flow to the security device first;
the device configuration module further configures the next-hop information of the non-security device onto the non-security device, so that the non-security device transmits the target flow to the security device according to the next-hop information of the non-security device.

4. The system according to claim 1, wherein the system further comprises:
a security cloud center module to analyze an unknown flow from a security device which is received by the security device during providing the security service to the target flow, and update a feature library based on the analysis result, so that the security device provides security service to the target flow by using the updated feature library.

5. The system according to claim 1, wherein, the system further comprises a security cloud center module,
the security cloud center module analyzes an unknown flow from a security device to generate a security policy, wherein the unknown flow is received by the security device during providing the security service to the target flow;
the security control center module further determines second service configuration information according to the security policy; and
the device configuration module configures the second service configuration information onto the security device, so that the security device provides security service according to the second service configuration information.

6. A method for providing security service, comprising:
receiving, by a security control center module in a security service providing system, security service information;
determining, by the security control center module, a security device for providing security service to the target flow and first service configuration information and next-hop information of the security device according to the security service information; and
configuring, by the security control center module, the first service configuration information and the next-hop information onto the security device, so that the security device provides the security service to the target flow according to the first service configuration information and forwards the target flow according to the next-hop information.

7. The method according to claim 6, wherein, in a case that the security service information includes one or more service types respectively associated with a service policy and a service order, determining the security device and the first service configuration information and the next-hop information of the security device includes:
determining, by the security control center module, the security device and the first service configuration information of the security device according to the service type and the service policy associated with the service type; and
determining, by the security control center module, the next-hop information of the security device according to the service order and the first service configuration information of the security device.

8. The method according to claim 6, further comprising:
determining, by the security control center module, the next-hop information of a non-security device immediately before a security device, wherein the non-security device is to forward the target flow to the security device first; and
configuring, by the security control center module, the next-hop information of the non-security device onto the non-security device, so that the non-security device transmits the target flow to the security device according to the next-hop information of the non-security device.

9. The method according to claim 6, after configuring the first service configuration information and the next-hop information of the security device onto the security device, the method further comprises:
receiving, by the security control center module, a security policy from a security cloud center module in the security service providing system, wherein the security cloud center module generates the security policy by analyzing an unknown flow from a security device and the unknown flow is received by the security device during providing the security service to the target flow;
determining, by the security control center module, second service configuration information according to the security policy; and
configuring, by the security control center module, the second service configuration information onto the security device, so that the security device provides security service according to the second service configuration information.

10. A security service providing device in a security service providing system, comprising a processor and a machine readable storage medium storing machine readable instructions corresponding to control logic for providing security service, and by executing the machine readable instructions, the processor is caused to:
receive security service information;
determine a security device for providing security service to the target flow, and first service configuration information and next-hop information of the security device according to the security service information; and
configure the first service configuration information and the next-hop information onto the security device, so that the security device provides the security service to the target flow according to its first service configuration information and forwards the target flow according to the next-hop information.

11. The device according to claim 10, wherein, in a case that the security service information includes one or more service types respectively associated with a service policy and a service order, for determining the security device and the first service configuration information and the next-hop information of the security device, the machine readable instructions further cause the processor to:
determine the security device and the first service configuration information of the security device according to the service type and the service policy associated with the service type; and
determine the next-hop information of the security device according to the service order and the first service configuration information of the security device.

12. The device according to claim 10, wherein, the machine readable instructions further cause the processor to:
determine the next-hop information of a non-security device wherein the non-security device is to forward the target flow to the security device first; and
configure the next-hop information of the non-security device onto the non-security device, so that the non-security device transmits the target flow to the security device according to the next-hop information of the non-security device.

13. The device according to claim 10, wherein, the machine readable instructions further cause the processor to:
receive a security policy from a security cloud center module in the security service providing system, wherein the security cloud center module generates the security policy by analyzing an unknown flow from a security device and the unknown flow is received by the security device during providing the security service to the target flow;
determine second service configuration information according to the security policy; and
configure the second service configuration information onto the security device, so that the security device provides security service according to the second service configuration information.
